(19) United States
(12) Patent Application Publication
(10) Pub. No.: US 2025/0376064 A1
(43) Pub. Date: Dec. 11, 2025

(54) WORK MACHINE CHARGING THERMAL DERATE

(71) Applicant: Caterpillar Inc., Peoria, IL (US)

(72) Inventors: Kea Voa Chin, Washington, IL (US); Dustin Craig Selvey, Eureka, IL (US); Gayatri Macha, Edwards, IL (US); Julianna Delgado, Peoria, IL (US); Adam K. Benedict, Cardington, OH (US); Sindhu Karnati, Dunlap, IL (US)

(73) Assignee: Caterpillar Inc., Peoria, IL (US)

(21) Appl. No.: 19/222,129

(22) Filed: May 29, 2025

Related U.S. Application Data
(60) Provisional application No. 63/657,758, filed on Jun. 7, 2024.

(51) Int. Cl. B60L 53/62; B60L 53/302

(52) U.S. Cl. CPC B60L 53/62; B60L 53/302; B60L 2200/40

(57) ABSTRACT

A method for managing power distribution in a charging system for a BEM, the method including: monitoring temperatures at multiple locations along the charging system within the BEM including: at a first charge port having a first input connector, a second charge port having a second input connector, at a first bus bar electrically coupled to the first input connector, at a second bus bar electrically coupled to the second input connector and within an enclosure that houses components of the charging system; determining a maximum power input for the BEM based on the monitoring the temperatures; applying a plurality of different temperature derate curves associated with the first input connector, the second input connector, the first bus bar, the second bus bar and the enclosure; aggregating the temperatures; and controlling power to the BEM such that a minimum power rating is applied based on the aggregating temperatures.

### CLAIM OF PRIORITY

This application claims the benefit of U.S. Provisional Patent Application Ser. No. 63/657,758, filed on Jun. 7, 2024, the benefit of priority of which is claimed hereby, and which is incorporated by reference herein in its entirety.

### TECHNICAL FIELD

This document relates to electric powered work machines and in particular to charging systems for such machines.

### BACKGROUND

Powering a large moving work machine (e.g., a wheel loader, a mining truck, etc.) with an electric motor requires a large mobile electric energy source that can provide current of up to thousands of Amperes (Amps). An example of a mobile energy source is a battery system containing multiple strings of high-capacity batteries. The batteries in each string are connected in series, and the strings of batteries are connected in parallel to provide the high output power needed by the electric powered work machines. The mobile energy source needs to be recharged when the energy source nears depletion. Different battery electric machines may have different power needs and charging needs.

Electric powered work machines require efficient and rapid charging solutions to minimize downtime and maximize operational efficiency. Aspects of traditional charging systems such as cables and charging ports may be utilized by such electric powered work machines for maneuverability, space and other requirements. As a result, traditional charging systems face challenges related to overheating, which can reduce the lifespan of some components. Avoiding overheating is typically managed by uniformly reducing the charging current, which extends the charging time and affects the overall performance of the electric powered work machines.

### SUMMARY OF THE INVENTION

Electric powered large moving work machines use large capacity battery systems that need charging, and the charging may need to be provided at a remote job site. However, the electric powered work machines at the job site may have different charging needs and requirements including regarding managing and accommodating thermal derate so as not to overheat electrical components of such machines.

In some aspects, the techniques described herein relate to a charging system for a battery electric machine (BEM), the system optionally including: a plurality of input connectors; a first plurality of temperature sensors coupled to the plurality of input connectors and configured to sense a first plurality of temperature data indicative of a first plurality of temperatures of the plurality of input connectors; a plurality of bus bars electrically coupled to the plurality of input connectors; a second plurality of temperature sensors coupled to the plurality of bus bars and configured to sense a second plurality of temperature data indicative of a second plurality of temperatures of the plurality of bus bars; an enclosure configured to house components of the charging system; at least one sensor configured to sense a third temperature data indicative of a temperature within the enclosure; and an electronic controller configured to receive the first plurality of temperature data, the second plurality of temperature data and the third temperature data and control an input current to the BEM based upon the first plurality of temperature data, the second plurality of temperature data and the third temperature data and based upon temperature derate curves for the plurality of input connectors, based upon temperature derate curves for the plurality of bus bars and based upon a temperature derate curve for the enclosure.

In some aspects, the techniques described herein relate to a method for managing power distribution in a charging system for a battery electric machine (BEM), the method including: monitoring temperatures at multiple locations along the charging system within the BEM including: at a first charge port having a first input connector, a second charge port having a second input connector, at a first bus bar electrically coupled to the first input connector, at a second bus bar electrically coupled to the second input connector and within an enclosure that houses components of the charging system; determining a maximum power input for the BEM based on the monitoring the temperatures; applying a plurality of different temperature derate curves associated with the first input connector, the second input connector, the first bus bar, the second bus bar and the enclosure; aggregating the temperatures; and controlling power to the BEM such that a minimum power rating is applied based on the aggregating temperatures.

In some aspects, the techniques described herein relate to a battery electric machine (BEM) including: a plurality of temperature sensors located along a charging system for the BEM including at a plurality of input connectors, at a plurality of bus bars electrically coupled to the plurality of input connectors and at an enclosure that houses components including components of the charging system; and an electronic control module (ECM) configured to control charging based on temperatures measured by the plurality of temperature sensors and based upon temperature derate curves for the plurality of input connectors, based upon temperature derate curves for the plurality of bus bars and based upon a temperature derate curve for the enclosure.

### BRIEF DESCRIPTION OF THE DRAWINGS

FIG. 1 is an elevation view depicting an example of a battery electric work machine in accordance with this disclosure.

FIG. 2 is a diagram of an example charging system for battery electric work machines in accordance with this disclosure.

FIG. 3 is a highly schematic diagram of an example a charging system on a battery electric work machine in accordance with this disclosure.

FIG. 4A is a graph showing temperature derate curves for a first input connector, a first bus bar and an enclosure in accordance with this disclosure.

FIG. 4B is a graph showing temperature derate curves for a second input connector, a second bus bar and the enclosure in accordance with this disclosure.

FIG. 5 is a flow diagram of an example of a method for managing power distribution in a charging system for a battery electric machine in accordance with this disclosure.

### DETAILED DESCRIPTION

Examples according to this disclosure are directed to devices, methods, and systems that improve charging of an battery electric work machine (BEM).

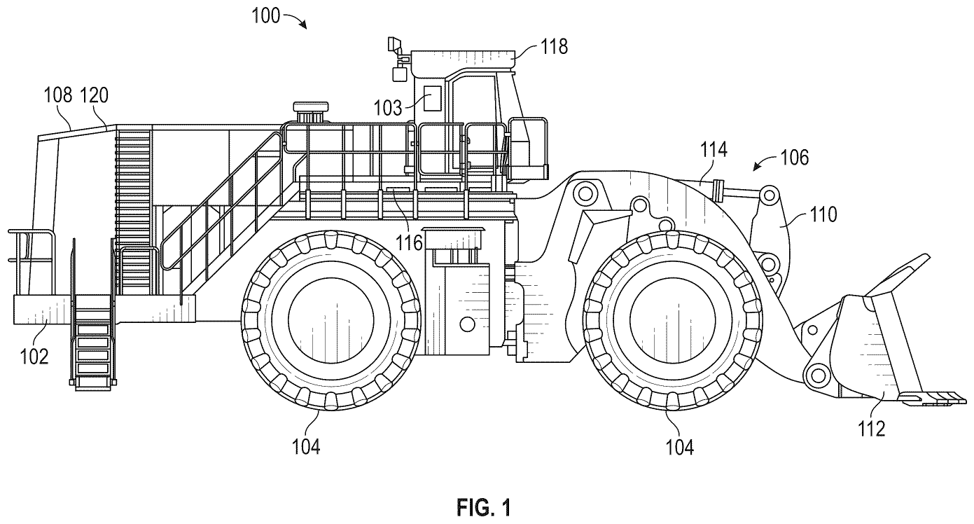

FIG. 1 depicts an example work machine that is a BEM 100 in accordance with this disclosure. In FIG. 1, BEM 100 includes frame 102, wheels 104, implement 106, and a speed control system implemented in one or more on-board or off-board electronic devices like, for example, an electronic control unit (ECU) or an electronic control module (ECM) 103. Example BEM 100 is a wheel loader. In other examples, however, the machine may be other types of machines related to various industries, including, as examples, construction, agriculture, forestry, transportation, material handling, waste management, marine, stationary power, and so on. Accordingly, although some examples are described with reference to a wheel loader machine, examples according to this disclosure are also applicable to other types of machines including graders, scrapers, dozers, excavators, compactors, material haulers like dump trucks, marine vessels, locomotives, along with other example machine types.

BEM 100 includes frame 102 mounted on four wheels 104, although, in other examples, the machine could have more than four wheels. Frame 102 is configured to support and/or mount one or more components of BEM 100. For example, BEM 100 includes enclosure 108 coupled to frame 102. Enclosure 108 can house, among other components, an electric motor(s) to propel the machine over various terrain via wheels 104, a battery system 120 and/or components of a charging system as discussed herein. In some examples, multiple electric motors are included in multiple enclosures at multiple locations of the BEM 100.

BEM 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of BEM 100.

Platform 116 is coupled to frame 102 and provides access to various locations on BEM 100 for operational and/or maintenance purposes. BEM 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control BEM 100 and/or the implement 106. Operator cabin 118 may also include an operator interface such as, a display device, a sound source, a light source, or a combination thereof.

BEM 100 can be used in a variety of industrial, construction, commercial or other applications. BEM 100 can be operated by an operator in operator cabin 118. The operator can, for example, drive BEM 100 to and from various locations on a work site and can also pick up and deposit loads of material using bucket 112 of implement 106. By further way of example, both operation by a remotely located operator and autonomous or robotic operation are contemplated. BEM 100 can be used to excavate a portion of a work site by actuating cylinders 114 to articulate bucket 112 via linkage assembly 110 to dig into and remove dirt, rock, sand, etc. from a portion of the work site and deposit this load in another location. BEM 100 can include a battery compartment connected to frame 102 such as in the enclosure 108 and including a rechargeable battery system 120. Battery system 120 is electrically coupled to the one or more electric motors of the battery electric work BEM 100.

The battery system 120 of different types of BEMs may have different charging needs and locations. The battery system 120 may differ in the amount of charge needed to fully charge the battery system 120, the rate at which the battery system can be charged, the maximum rating of charging energy, etc.

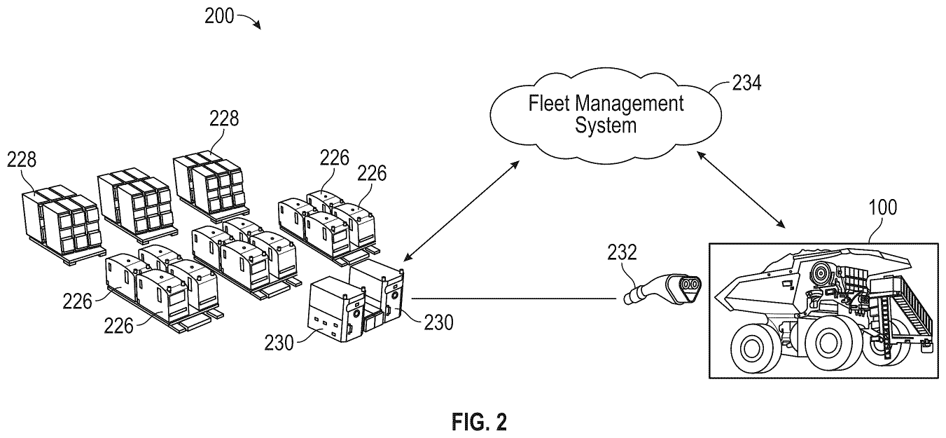

FIG. 2 is a diagram of an example of a charging system 200 for a battery electric BEM 100. The system 200 includes multiple charger devices 226. Each charger device 226 is configured to provide high-capacity charge energy for charging a BEM 100. Each of the charger devices 226 can be coupled to one or more switch devices 228 that connect the charger device 226 to a grid, a generator set device, etc. The charging system 200 also includes at least one charge dispenser device 230. Multiple charger devices 226 are connected to one charge dispenser device 230 to provide charging energy in parallel to the charge dispenser device 230. The example system of FIG. 2 includes two charge dispensers and one to six charger devices 226 can be connected to each charge dispenser device 230 in the example.

The charge dispenser device 230 is connected to the BEM 100 by a charging cable 232 and plug. The charging cable 232 may be air-cooled or liquid-cooled depending on the capacity of the charging cable 232. A charge dispenser device 230 aggregates the charging energy from the charger devices 226 connected to it to provide the aggregated charging energy to the BEM 100 through the charging cable 232. This makes the charging system 200 modular and the charging energy produced from any of one to six chargers can be received in parallel and aggregated in the example system of FIG. 2. In some examples, more than six charger devices 226 can be connected to one charge dispenser device 230 and the charge from more than six charger devices can be aggregated by the changer dispenser device 230.

The BEMs 100 being charged may be automated and may operate without a human operator. Operation of the BEMs may be through a fleet management system 234. The fleet management system 234 may be implemented through one or more servers located at the remote site, or the one or more servers may be cloud-based. The fleet management system 234 manages the displacements of the automated BEMs 100 at the job site. The fleet management system 234 may communicate with the BEMs 100 and charge dispenser device 230 wirelessly (e.g., wireless WiFi). The fleet management system 234 sends specific instructions to the BEMs 100 to move them on specific lanes across the job site. When the fleet management system 234 determines that a BEM 100 needs charging, the fleet management system 234 may match a BEM 100 to a charge dispenser device 230 based on the charge dispenser's location, availability, and capacity. Upon connection to the BEM 100, the charge dispenser device 230 will automatically start a charging session. On completion, the charge dispenser device 230 may notify the fleet management system 234 that the BEM 100 can leave.

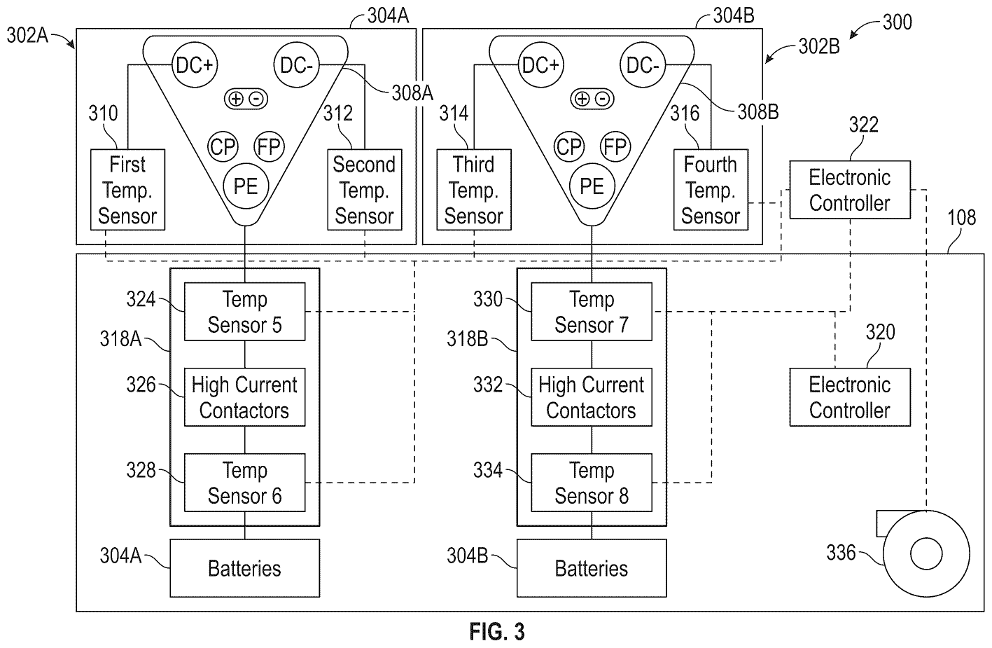

FIG. 3 is a schematic diagram of an example charging system 300 for charging a BEM. The system 300 is located on the BEM (e.g., BEM 100). The charging system 300 can be at least partially housed within the enclosure 108 along with other components (e.g., batteries, electric motors, components of the charging system 300 not specifically illustrated, etc.). In the example of FIG. 3, the system 300 includes a first charge port 302A and a second charge port 302B. Thus, multiple charge ports such as for parallel charging of batteries 304A and 304B are contemplated. Other examples contemplate the use of third, etc. charge ports as desired.

The first charge port 302A can include a first inlet 306A with a first input connector 308A, a first temperature sensor 310 and a second temperature sensor 312. The second charge port 302B can include a second inlet 306B with a second input connector 308B, a third temperature sensor 314 and a fourth temperature sensor 316. The system 300 further includes a first bus bar 318A, a second bus bar 318B, an enclosure temperature sensor 320 and an electronic controller 322. The first bus bar 318A can include a fifth temperature sensor 324, a high current contactor(s) 326 and a sixth temperature sensor 328. The second bus bar 318B can include a seventh temperature sensor 330, a high current contractor(s) 332 and an eight temperature sensor 334. The enclosure 108 can include a cooling device 336 such as a fan or blower.

The first charge port 302A and the second charge port 302B can have any suitable configuration to facilitate electrical charging. Thus, the construction including the first inlet 306A with the first input connector 308A and the second inlet 306B with the second input connector 308B is shown purely for exemplary purposes. The first input connector 308A and the second input connector 308B are illustrated as having a pen and socket configuration with a DC positive contact and DC negative contact. However, other configurations for the input connector 308A and the second input connector 308B are contemplated.

The first temperature sensor 310 can be located at the first inlet 306A, for example, such as being located on or embedded in the first input connector 308A. It is desirable to locate the first temperature sensor 310 as close to the DC positive contact as possible according to some examples for more accurate temperature sensing. The second temperature sensor 312 can be located at the first inlet 306A. This can include having the second temperature sensor 312 located on or embedded in the first input connector 308A. It is desirable to locate the second temperature sensor 312 as close to the DC negative contact as possible according to some examples for more accurate temperature sensing.

The third temperature sensor 314 can be located at the second inlet 306B, for example, such as being located on or embedded in the second input connector 308B. It is desirable to locate the third temperature sensor 314 as close to the DC positive contact as possible according to some examples for more accurate temperature sensing. The fourth temperature sensor 316 can be located at the second inlet 306B. This can include having the fourth temperature sensor 316 located on or embedded in the second input connector 308B. It is desirable to locate the fourth temperature sensor 316 as close to the DC negative contact as possible according to some examples for more accurate temperature sensing.

The first bus bar 318A can be electrically coupled to the first charge port 302A including being electrically coupled to the first input connector 308A. The second bus bar 318B can be electrically coupled to the second charge port 302B including being electrically coupled to the second input connector 308B. The first bus bar 318A and the second bus bar 318B can optionally be located within the enclosure 108. However, the first bus bar 318A and the second bus bar 318B may not be located within the enclosure 108 according to other examples. The batteries 304A can be electrically coupled to the first bus bar 318A and the batteries 304B can be electrically coupled to the second bus bar 318B. The batteries 304A and 304B can be located within the enclosure 108 according to some examples. However, other examples contemplate the batteries 304A and 304B located in a different location on the BEM.

For the first bus bar 318A, the fifth temperature sensor 324 can be located between the first input connector 308A and the high current contactor(s) 326. The sixth temperature sensor 328 is located after the high current contactor(s) 326. For the second bus bar 318B, the seventh temperature sensor 330 can be located between the second input connector 308B and the high current contactor(s) 332. The eighth temperature sensor 334 is located after the high current contactor(s) 332. Although not illustrated in FIG. 3, the system 300 can include further temperature sensors not otherwise indicated such as on both positive and negative bus bars (bus bars 318A and 318B are shown generically in FIG. 3).

The enclosure temperature sensor 320 can be positioned within the enclosure 108 and is configured to sense a temperature of the air within the enclosure 108. The cooling device 336 can be located within or partially within the enclosure 108 and can be a fan or blower or other device configured to cool and/or circulate the air within the enclosure 108 such as by exchange of the air of the enclosure 108 with ambient air.

The electronic controller 322 can be the ECM 103 (FIG. 1), another controller or sub-controller, for example. The electronic controller 322 can electronically communicate with the first temperature sensor 310, the second temperature sensor 312, the third temperature sensor 314, the fourth temperature sensor 316, the enclosure temperature sensor 320, the fifth temperature sensor 324, the sixth temperature sensor 328, the seventh temperature sensor 330, the eight temperature sensor 334 and the cooling device 336, for example. The electronic controller 322 can receive temperature data indicative of temperatures sensed by the first temperature sensor 310, the second temperature sensor 312, the third temperature sensor 314, the fourth temperature sensor 316, the enclosure temperature sensor 320, the fifth temperature sensor 324, the sixth temperature sensor 328, the seventh temperature sensor 330 and the eight temperature sensor 334. As further discussed herein, the electronic controller 322 can be configured to control input current to the BEM based upon the temperature data from one or more (including up to all) of the sensors 310, 312, 314, 316, 320, 324, 328, 330 and 334 and based upon temperature derate curves for the first and second of input connectors 308A and 308B, based upon temperature derate curves for the first and second bus bars 318A and 318B and based upon a temperature derate curve for the enclosure 108.

The electronic controller 322 can include various functionality including the electronic controller 322 is configured to independently control the input current to individual ones of the first input connector 308A and the second input connector 308B and associated first bus bar 318A and second bus bar 318B to optimize power to the BEM. Thus, the electronic controller 322 can vary charging between the first charge port 302A and the second charge port 302B based on one or more temperatures experienced at the first inlet 306A of the first charge port 302A and at a second inlet 306B of the second charge port 302B to optimize charge rate.

The electronic controller 322 can limit input current solely contingent upon the temperature derate curve of the enclosure 108 as further discussed herein. The electronic controller 322 is configured to apply a different input current to the first charge port 302A than the second charge port 302B to optimize available power to the BEM. The electronic controller 322 can control the input current based upon applicable of the temperature derate curves related to the first charge port 302A (e.g., the temperature derate curves for the first input connector 308A and/or the first bus bar 318A) independent of applicable of the temperature derate curves related to the second charge port 302B (e.g., the temperature derate curves for the second input connector 308B and/or the second bus bar 318B).

The electronic controller 322 is configured to control operation (e.g., operation mode off, operation mode on low, operation mode on high, etc.) of the cooling device 336 based upon temperature data from the enclosure temperature sensor 320, ambient temperature and based upon the temperature derate curve for the enclosure 108, for example. The electronic controller 322 can use the temperature data indicative of temperatures sensed by the first temperature sensor 310, the second temperature sensor 312, the third temperature sensor 314, the fourth temperature sensor 316, the enclosure temperature sensor 320, the fifth temperature sensor 324, the sixth temperature sensor 328, the seventh temperature sensor 330 and the eight temperature sensor 334 for diagnostics to identify one or more components that have a potential to fail. According to one example, the electronic controller 322 aggregates all the data indicative of temperatures including temperature data from the enclosure temperature sensor 320 and derates to a minimum power rating to determine the input current.

The electronic controller 322 can include, for example, software, hardware, and combinations of hardware and software configured to execute several functions related to, among others, charging of the BEM. The electronic controller 322 can be an analog, digital, or combination analog and digital controller including a number of components. As examples, the electronic controller 322 can include integrated circuit boards or ICB(s), printed circuit boards PCB(s), processor(s), data storage devices, switches, relays, or any other components. Examples of processors can include any one or more of a microprocessor, a controller, a digital signal processor (DSP), an application specific integrated circuit (ASIC), a field-programmable gate array (FPGA), or equivalent discrete or integrated logic circuitry. Commercially available microprocessors can be configured to perform the functions of the electronic controller 322. Various known circuits may be associated with electronic controller 322, including power supply circuitry, signal-conditioning circuitry, actuator driver circuitry (i.e., circuitry powering solenoids, motors, or piezo actuators), and communication circuitry. In some examples, the electronic controller 322 may be positioned on the BEM, while in other examples the electronic controller 322 may be positioned at an off-board location (remote location) relative to the BEM.

The electronic controller 322 can include a memory such as memory circuitry. The memory may include storage media to store and/or retrieve data or other information such as, for example, temperature data from the first temperature sensor 310, the second temperature sensor 312, the third temperature sensor 314, the fourth temperature sensor 316, the enclosure temperature sensor 320, the fifth temperature sensor 324, the sixth temperature sensor 328, the seventh temperature sensor 330 and the eight temperature sensor 334, data from a communication device, etc. Storage devices, in some examples can be a computer-readable storage medium. The data storage devices can be used to store program instructions for execution by processor(s) of the electronic controller 322, for example. The storage devices, for example, are used by software, applications, algorithms, as examples, running on and/or executed by the electronic controller 322. The storage devices can include short-term and/or long-term memory and can be volatile and/or non-volatile. Examples of non-volatile storage elements include magnetic hard discs, optical discs, floppy discs, flash memories, or forms of electrically programmable memories (EPROM) or electrically erasable and programmable (EEPROM) memories. Examples of volatile memories include random access memories (RAM), dynamic random-access memories (DRAM), static random-access memories (SRAM), and other forms of volatile memories known in the art.

The systems 200 and/or 300 can include one or more remote servers, processors, or other such computing devices such as the electronic controller 322. In some examples, the electronic controller 322 can be connected to one another and/or otherwise in communication with one another and with various components such as the first temperature sensor 310, the second temperature sensor 312, the third temperature sensor 314, the fourth temperature sensor 316, the enclosure temperature sensor 320, the fifth temperature sensor 324, the sixth temperature sensor 328, the seventh temperature sensor 330 and the eight temperature sensor 334 and/or other components of BEM (see discussion above) or offboard components via a network. The network may be a local area network (“LAN”), a larger network such as a wide area network (“WAN”), or a collection of networks, such as the Internet. Protocols for network communication, such as TCP/IP, may be used to implement the network. Although examples are described herein as using a network such as the Internet, other distribution techniques may be implemented that transmit information.

The systems 200 and/or 300 can, in the context of software, include steps that represent computer-executable instructions stored in memory. When such instructions are executed by, for example, the electronic controller 322, such instructions cause the electronic controller 322, various components of the systems 200 and 300, and/or BEM, generally, to perform operations. The computer-executable instructions may include routines, programs, objects, components, data structures, and the like that perform particular functions or implement particular abstract data types. The order in which the operations are described is not intended to be construed as a limitation, and any number of the described steps can be combined in any order and/or in parallel to implement the process for the BEM of FIG. 1 and components of the system 200 or system 300.

### INDUSTRIAL APPLICABILITY

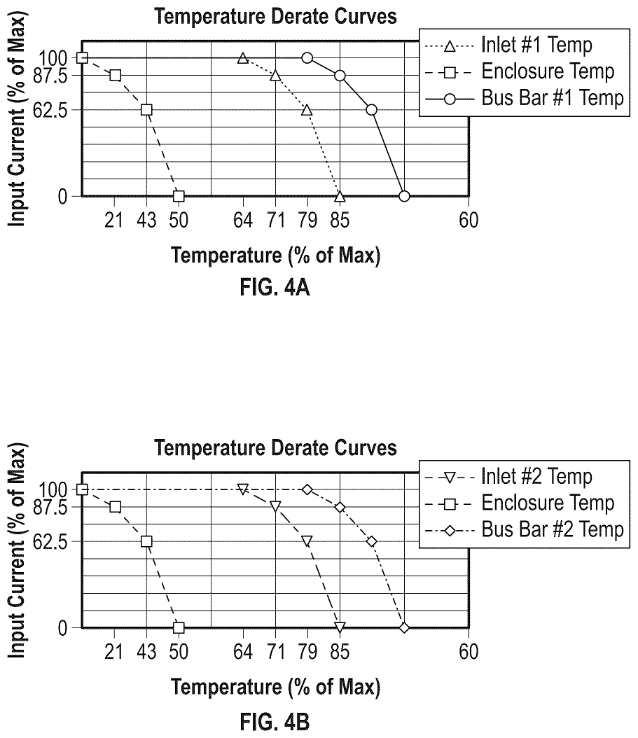

FIGS. 4A and 4B illustrate temperature derivative curves as graphs. However, lookup tables, algorithms and other methodology for use are also contemplated. FIG. 4A shows the temperature derivative curve for the first input connector 308A (FIG. 3), the temperature derate curve for the first bus bar 318A (FIG. 3) and the temperature derate curve for the enclosure 108 (FIG. 3). FIG. 4B shows the temperature derivative curve for the second input connector 308B (FIG. 3), the temperature derate curve for the second bus bar 318B (FIG. 3) and the temperature derate curve for the enclosure 108 (FIG. 3). Graphically, the temperature derate curve for the first input connector is identical to the temperature derate curve for the second input connector and the temperature derate curve for the first bus bar is identical to the temperature derate curve for the second bus bar. However, during operation experience has shown that individual temperatures along the curve can vary due to component wear, operating environment and other factors. Thus, for example, the first input connector may rapidly warm to 85% of a maximum allowable temperature such that input current to the first charge port 302A (FIG. 3) needs to controlled to be reduced to zero. However, at the same time, the second input connector may only warm to 71% of the maximum allowable temperature such that input current to the second charge port 302B (FIG. 3) can be controlled to be reduced to 87.5% of the maximum input current. Thus, charging via the second charge port 302B (FIG. 3) can proceed, while charging via the first charge port 302A (FIG. 3) must be halted. In this manner, the controller (e.g., electronic controller 322 of FIG. 3) is configured to independently control the input current to individual ones of the plurality of input connectors and associated individual ones of the plurality of bus bars to optimize power to the BEM. This difference in temperatures at any point in time can be captured and logged for diagnostics such that the controller (e.g., electronic controller 322 of FIG. 3) can flag a possible component degradation and notify that maintenance/service should be performed.

Additionally, the controller (e.g., electronic controller 322 of FIG. 3) can limit input current solely contingent upon the temperature derate curve of the enclosure 108 (FIGS. 1 and 3) as the enclosure can contain critical components (e.g., the batteries, the electric motor(s), circuit boards etc.) that cannot overheat without a critical failure. The controller (e.g., electronic controller 322 of FIG. 3) can be configured to aggregate various temperature data (e.g., temperature data from the first temperature sensor 310, the second temperature sensor 312, the third temperature sensor 314, the fourth temperature sensor 316, the enclosure temperature sensor 320, the fifth temperature sensor 324, the sixth temperature sensor 328, the seventh temperature sensor 330 and the eight temperature sensor 334) and can compare each of these data points gathered/monitored at any point in time to applicable temperature derate curves. As are result of such monitoring, the controller can be configured to derate to a minimum power rating to determine the input current. Put another way, power is controlled to the BEM such that a minimum power rating is applied based on the aggregating of the sensed temperatures.

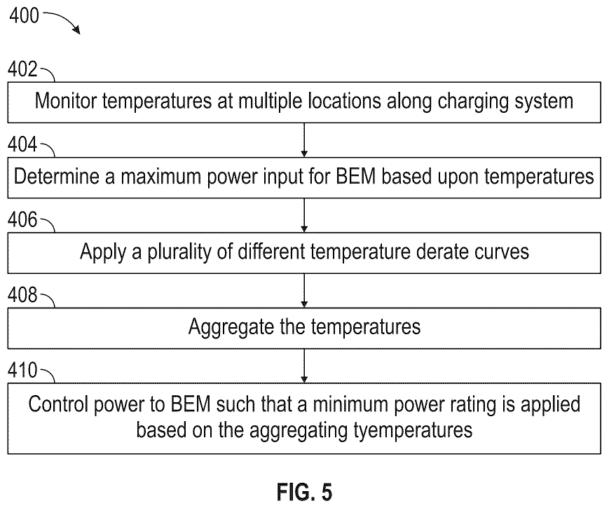

FIG. 5 is a flow chart of an exemplary method 400 for managing power distribution in a charging system for the BEM. The method 400 can include monitoring 402 temperatures at multiple locations along the charging system within the BEM including: at a first charge port having a first input connector, a second charge port having a second input connector, at least a first bus bar electrically coupled to the first input connector, at least a second bus bar electrically coupled to the second input connector and within an enclosure that houses components of the charging system. The method 400 can include determining 404 a maximum power input for the BEM based on the monitoring the temperatures. The method 400 can include applying 406 a plurality of different temperature derate curves associated with the first input connector, the second input connector, the first bus bar, the second bus bar and the enclosure. The method 400 can include aggregating 408 the temperatures. The method 400 can include controlling 410 power to the BEM such that a minimum power rating is applied based on the aggregating temperatures.

Optionally the method 400 can include controlling input current to the first charge port independent of input current to the second charge port. The method 400 can include varying charging between the first charge port and the second charge based on one or more temperatures experienced at a first inlet of the first charge port and at a second inlet of the second charge port to optimize charge rate. The method 400 can include using temperature data from the monitoring the temperatures for diagnostics to identify one or more components that have a potential to fail.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. A charging system for a battery electric machine (BEM), the system comprising:
a plurality of input connectors;
a first plurality of temperature sensors coupled to the plurality of input connectors and configured to sense a first plurality of temperature data indicative of a first plurality of temperatures of the plurality of input connectors;
a plurality of bus bars electrically coupled to the plurality of input connectors;
a second plurality of temperature sensors coupled to the plurality of bus bars and configured to sense a second plurality of temperature data indicative of a second plurality of temperatures of the plurality of bus bars;
an enclosure configured to house components of the charging system;
at least one sensor configured to sense a third temperature data indicative of a temperature within the enclosure; and
an electronic controller configured to receive the first plurality of temperature data, the second plurality of temperature data and the third temperature data and control an input current to the BEM based upon the first plurality of temperature data, the second plurality of temperature data and the third temperature data and based upon temperature derate curves for the plurality of input connectors, based upon temperature derate curves for the plurality of bus bars and based upon a temperature derate curve for the enclosure.

2. The charging system of claim 1, wherein the controller is configured to independently control the input current to individual ones of the plurality of input connectors and associated individual ones of the plurality of bus bars to optimize power to the BEM.

3. The charging system of claim 2, further comprising a cooling device for the enclosure, wherein the controller is configured to control operation of the cooling device for the enclosure based upon the third temperature data.

4. The charging system of claim 3, wherein the controller limits input current solely contingent upon the third temperature data and the temperature derate curve of the enclosure.

5. The charging system of claim 1, wherein the plurality of input connectors include at least a first input connector and a second input connector, and wherein the plurality of bus bars include at least a first bus bar electrically coupled to the first input connector and a second bus bar electrically coupled to the second input connector, wherein the first input connector includes a first temperature sensor and a second temperature sensor and the second input connector includes a third temperature sensor and a fourth temperature sensor.

6. The charging system of claim 5, wherein the first temperature sensor and the second temperature sensor are embedded in the first input connector adjacent a positive contact and a negative contact, respectively, and wherein the third temperature sensor and the fourth temperature sensor are embedded in the second input connector adjacent a positive contact and a negative contact, respectively.

7. The charging system of claim 5, wherein the first bus bar includes a fifth temperature sensor and a sixth temperature sensor, and wherein the fifth temperature sensor is located between the first input connector and a first high current contactor and the sixth temperature sensor is located after the first high current contactor.

8. The charging system of claim 7, wherein the second bus bar includes a seventh temperature sensor and an eighth temperature sensor, and wherein the seventh temperature sensor is located between the second input connector and a second high current contactor and the eighth temperature sensor is located after the second high current contactor.

9. The charging system of claim 8, wherein the electronic controller is configured to receive data indicative of temperatures from the first temperature sensor, the second temperature sensor, the third temperature sensor, the fourth temperature sensor, the fifth temperature sensor, the sixth temperature sensor, the seventh temperature sensor and the eighth temperature sensor, and control the input current to the BEM based upon the data and based upon temperature derate curves for the first input connector, temperature derate curves for the second input connector, temperature derate curves for the first bus bar and temperature derate curves for the second bus bar.

10. The charging system of claim 9, wherein the first input connector is located at a first inlet comprising a first charge port and the second input connector is located at a second inlet for a second charge port, wherein controller is configured to apply a different input current to the first charge port than the second charge port to optimize available power to the BEM.

11. The charging system of claim 10, wherein the controller controls the input current based upon applicable of the temperature derate curves related to the first charge port independent of applicable of the temperature derate curves related to the second charge port.

12. The charging system of claim 9, wherein the controller is configured to use the data indicative of temperatures from the first temperature sensor, the second temperature sensor, the third temperature sensor, the fourth temperature sensor, the fifth temperature sensor, the sixth temperature sensor, the seventh temperature sensor and the eighth temperature sensor for diagnostics to identify one or more components that have a potential to fail.

13. The charging system of claim 9, wherein the controller aggregates all the data indicative of temperatures and the third temperature data and derates to a minimum power rating to determine the input current.

14. The charging system of claim 1, wherein the controller is an electronic control module (ECM) of the BEM.

15. A method for managing power distribution in a charging system for a battery electric machine (BEM), the method comprising:
monitoring temperatures at multiple locations along the charging system within the BEM including: at a first charge port having a first input connector, a second charge port having a second input connector, at a first bus bar electrically coupled to the first input connector, at a second bus bar electrically coupled to the second input connector and within an enclosure that houses components of the charging system;
determining a maximum power input for the BEM based on the monitoring the temperatures;
applying a plurality of different temperature derate curves associated with the first input connector, the second input connector, the first bus bar, the second bus bar and the enclosure;
aggregating the temperatures; and
controlling power to the BEM such that a minimum power rating is applied based on the aggregating temperatures.

16. The method of claim 15, further comprising controlling input current to the first charge port independent of input current to the second charge port.

17. The method of claim 16, wherein charging is varied between the first charge port and the second charge port based on one or more temperatures experienced at a first inlet of the first charge port and at a second inlet of the second charge port to optimize charge rate.

18. The method of claim 15, further comprising using temperature data from the monitoring the temperatures for diagnostics to identify one or more components that have a potential to fail.

19. A battery electric machine (BEM) comprising:
a plurality of temperature sensors located along a charging system for the BEM including at a plurality of input connectors, at a plurality of bus bars electrically coupled to the plurality of input connectors and at an enclosure that houses components including components of the charging system; and
an electronic control module (ECM) configured to control charging based on temperatures measured by the plurality of temperature sensors and based upon temperature derate curves for the plurality of input connectors, based upon temperature derate curves for the plurality of bus bars and based upon a temperature derate curve for the enclosure.

20. The battery electric machine of claim 19, wherein the plurality of input connectors include at least a first input connector and a second input connector, and wherein the plurality of bus bars include at least a first bus bar electrically coupled to the first input connector and a second bus bar electrically coupled to the second input connector, wherein the first input connector includes a first temperature sensor and a second temperature sensor and the second input connector includes a third temperature sensor and a fourth temperature sensor, wherein the first bus bar includes a fifth temperature sensor and a sixth temperature sensor, and wherein the fifth temperature sensor is located between the first input connector and a first high current contactor and the sixth temperature sensor is located after the first high current contactor, wherein the second bus bar includes a seventh temperature sensor and an eighth temperature sensor, and wherein the seventh temperature sensor is located between the second input connector and a second high current contactor and the eighth temperature sensor is located after the second high current contactor, wherein the electronic controller configured to receive data indicative of temperatures from the first temperature sensor, the second temperature sensor, the third temperature sensor, the fourth temperature sensor, the fifth temperature sensor, the sixth temperature sensor, the seventh temperature sensor and the eighth temperature sensor, and control input current to the BEM based upon the data and based upon temperature derate curves for the first input connector, temperature derate curves for the second input connector, temperature derate curves for the first bus bar and temperature derate curves for the second bus bar, and wherein the controller aggregates all the data indicative of the temperatures and the third temperature data and derates to a minimum power rating to determine the input current.
